(19) United States
(12) Patent Application Publication
(10) Pub. No.: US 2010/0135369 A1
(43) Pub. Date: Jun. 3, 2010

(54) INTERACTION BETWEEN AN INPUT DEVICE AND A TERMINAL DEVICE

(75) Inventors: Erich Hagl, Wien (AT); Peter Hagl, Wien (AT); Markus Moser, Graz (AT); Martin Pelzmann, Graz (AT); Matthias Zimmermann, Wien (AT)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 12/451,424

(22) PCT Filed: May 7, 2008
(86) PCT No.: PCT/EP2008/055619

§ 371 Date: Nov. 12, 2009

(30) Foreign Application Priority Data
May 11, 2007 (EP) 07009525.2

(51) Int. Cl. G09G 5/00; H04B 1/38

(52) U.S. Cl. 375/219; 345/156

(57) ABSTRACT

An input device interacts with a terminal device and/or controls the terminal device of a communication network. The terminal device serves to receive and to transmit a content data stream which represents a chat transmission. In addition, the terminal device functions to transmit messages created by the input device to a processing unit of the communication network. The input device has at least one sensor for determining a physical state of an operator of the input device. The input device is furthermore designed to transmit a value representing the physical state to the terminal and/or the processing unit.

### CROSS REFERENCE TO RELATED APPLICATIONS

This application is based on and hereby claims priority to PCT Application No. PCT/EP2008/055619 filed on May 7, 2008 and EP Application No. EP07009525 filed on May 11, 2007, the contents of which are hereby incorporated by reference.

### BACKGROUND OF THE INVENTION

The invention relates to an input device for interaction with a terminal device and/or for controlling the terminal device of a communication network.

Through the transmission of entertainment programs by using the Internet Protocol it will in future be possible for users to participate interactively in the entertainment program. In the context of the present description, a user is understood to be a viewer of a television transmission or a listener to a radio transmission. At present, in this situation the interactivity is restricted to taking part in a vote or other simple operations, such as reading specific emails for example

Within the framework of a voting process, a plurality of choices is offered to the user for example, from which the user can select a favored or correct response. The selection, in other words the voting, has hitherto mostly taken place by using a communication terminal device, such as a telephone for example. Furthermore, consideration has been given more recently to being able to carry out a vote by using the terminal device present for receiving the content data stream, a set-top box for example. In this case, the user operates an appropriate input facility on an input device of the terminal device in order to select his preferred response.

The utilization of the back channel present in the case of entertainment programs sent using the Internet Protocol for implementing and also processing complex functionalities has not previously been possible.

### SUMMARY

One possible object is to provide a capability which serves to make it easier for users to participate in entertainment programs, wherein an interactivity with the users is part of the entertainment program. A particular object is to create an input device for a terminal device, which improves the participation in an interactive entertainment program. Another potential goal is to specify a method with which a multi-stage interaction process is made possible for participants in the entertainment program.

The inventors propose an input device for interaction with a terminal device and/or for controlling the terminal device of a communication network, which has at least one sensor for sensing a physical state of an operator of the input device and is furthermore designed to transmit a value representing the physical state to a processing unit of the communication network. The terminal device serves to receive and to output a content data stream representing an entertainment program, which is sent to a plurality of such terminal devices. The terminal device is capable of transmitting messages created by the input device to a processing unit of the communication network.

With regard to the terminal device, this can for example be a television set, a radio set or a set-top box for connection to one of the aforementioned devices. Through the use of the input device it is possible to set up a back channel for the terminal device to the communication network in order to be able to exert influence on an entertainment program in a single-stage or multi-stage process. In this situation, the exertion of influence occurs having regard to the value representing the physical state. Exertion of influence can for example be a change in the content of the entertainment program.

The terminal device serves to receive and to output a content data stream which represents an entertainment program. The terminal device is capable of transmitting messages created by the input device to a processing unit of the communication network. A proposed method provides a multi-stage interaction process for users in a communication network. The communication network comprises a processing unit and a means for transmitting a content data stream representing an entertainment program, in particular simultaneously, to a plurality of terminal devices for output of the content data stream, whereby the terminal devices are designed in order to transmit messages to the processing unit.

According to one embodiment, the at least one sensor is designed to sense skin moisture content, sweat, a pulse or a heart rate. As a result, the input device has the ability to determine a physical state corresponding to an emotion of the user and to transmit this to the processing unit.

The proposed input device can be designed for the purpose of communication with the terminal device and/or a further input device. In the latter case, communication can take place amongst a plurality of input devices which for example are assigned to one and the same terminal device. The terminal device or one of the terminal devices can for example carry out a preprocessing of the respective physical states, sensed by the input devices, of their operators and transmit a value representing the totality of the physical states of the majority of users to the processing unit of the communication network. In this manner, the processing effort on the part of the communication network is simplified.

According to a further embodiment, the input device can have at its disposal an input facility by which the content of a message to be transmitted by way of the terminal device to the processing unit can be created and/or entered. For example, the input device can have a numeric and/or alphabetic keypad, by which a user can enter a complex (text) message. The input device can alternatively or additionally also have keys with special functions assigned, which when actuated execute a particular, predefined action. Keys of this type are for example color coded keys, such as can be found on normal remote controls for television sets.

The transmission of a message from the input device to the processing unit takes place basically through the intermediary of the terminal device which receives the data sent by the input device and transmits it to the processing unit in accordance with the transmission protocol used by the communication network. According to a further embodiment, a unique identifier for the terminal device is inserted into the message during the transmission of the message to be transmitted to the processing unit.

According to a further embodiment, a unique identifier is assigned to the input device itself, which identifier is inserted into the messages during the transmission of a message to the processing unit.

In a further development, the input device has at its disposal an analysis and/or evaluation unit for the sensor data acquired by this and/or data entered by way of the input facility. In this manner, the terminal device and also the processing unit of the communication network are relieved of the task of processing a high volume of data. In particular, a preprocessing of data by the input device is possible. In this situation, the preprocessing can also include the data sent by other input devices.

The data transmission between the input device and the terminal device as well as between input devices themselves can be implemented in wireless and/or wired fashion.

The input device can furthermore be provided with a reading device which can be used to read out the data from an identification medium. With regard to the reading device, this can for example be an RFID reader (RFID=radio frequency identification) which reads out data stored on a chip card. The data in question can in particular be an identifier which is assigned to a user, or operator, of the input device. Thus it is possible for example to assign the data acquired by the input device to a particular user if the latter has identified himself to the input device with his identification medium by way of the reading device prior to operation of the input device or prior to acquisition of the physical data.

A proposed terminal device is provided for connection to a communication network and for receiving and for outputting a content data stream representing an entertainment program. The terminal device is designed in particular as a set-top box. Communication between the terminal device and the communication network preferably takes place using the Internet Protocol. The terminal device has a first facility for analyzing and/or for evaluating data which has been transmitted by at least one input device, which is designed in the manner described above, to the terminal device. The terminal device furthermore has a second facility for transmitting the information determined by the first facility to a processing unit of the communication network. The terminal device is thus designed for preprocessing information acquired by the input device or devices. In this manner, the processing effort on the part of the communication network, in particular the processing unit, is reduced.

With regard to the method for providing a multi-stage interaction process for users in a communication network, comprising a processing unit, a transmitter for, in particular simultaneous, transmission of a content data stream representing an entertainment program to a plurality of terminal devices for output of the content data stream, whereby the terminal devices are designed for transmitting messages to the processing unit, a unique identifier is assigned in each case to each user. Each user is assigned by the processing unit to a particular role from a plurality of roles in the entertainment program, whereby the assignment is made through the evaluation of a plurality of first messages sent by the users, which include the identifiers assigned to a respective user. A result parameter is determined for the first role through the evaluation of second messages from the users assigned to a first role in response to a plurality of selection options contained in the content data stream. The result parameter for the first role is then used as an input parameter for at least one second role, such that the activity of the second role is influenced.

Within the framework of the method a “back channel” is used in order to enable multi-stage processes which enable a user to influence the events of the entertainment program. To this end, the users are classified into roles and question profiles or selection options are defined for the respective roles. A plurality of users are combined in one role. This makes it possible to bundle individual opinions of the users, such that the processing of a plurality of participants in the interactive entertainment program by the processing unit of the communication network can be carried out in a simplified manner. The role classification additionally enables a consensus to be reached, which occurs as a result of evaluating the first messages from the messages sent by the viewers. Through a majority decision, resulting for example from responding to prespecified questions or selection options, the participants are in a position for example to influence a defined or prespecified action in the entertainment program. The transmission of the first and/or second messages from the participants by way of the terminal device to the processing unit of the communication network can in this situation include physical states which for example are caused by emotions brought about by following the entertainment program. These can be interpreted by the processing unit and/or the terminal device and/or the input device such that they serve as influencing parameters.

Through repeated execution of the method it is possible to allow the plot line of the entertainment program to be influenced interactively by the users.

According to one embodiment, the assignment of a participant to one of the roles switches during the course of the transmission. In addition, participants with defined characteristics can be assigned to the same role.

In one development, the assignment of the role is effected through the specification of selection options by the processing unit and the evaluations of the messages sent in response thereto from the participants. The sending of the messages can take place with the aid of the input device described in the introduction.

The input device as a multimedia element can be connected to the terminal device (the set-top box of a television set, for example) and can translate the physical reactions of the viewer, brought about by emotions, into values representing the latter. It is possible in this situation, as already explained in the introduction, for a plurality of the input devices to communicate with one another. One or more or all of the input devices can communicate with the terminal device, whereby the participants operating the input devices can have different roles or the same role. To make a distinction, it is advantageous for the input device to have a unique identifier which is transmitted in addition to a network address of the terminal device.

According to a further embodiment, the assignment of the role is effected through the specification of a selection menu and the evaluation of the messages sent in response thereto from the participants.

A profile with characteristics is advantageously defined for each role.

Furthermore, provision is made that questions or selection options are defined for each role, which are transmitted to the terminal devices of the participants in one role or the participants in all roles.

According to a further embodiment, the messages sent from the terminal devices of the participants in a role are processed jointly by the processing unit.

Furthermore, provision is made that the messages sent from the terminal devices of the participants contain information corresponding to an emotion.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a process based on the proposal with regard to execution of the method, and

FIG. 2 shows a schematic representation of the system based on the proposal.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

In the context of the following description, the concept of the viewer is used as a synonym for a participant. In this connection the viewer concept stands as a collective term for an audience, for example a television audience, a user and the like. The viewer is thus a physical person who is able to actively participate through the method according to the inventors' proposals in an entertainment program and has the ability to express his opinion individually.

The concept of a role is understood to be a categorization or classification, under which a viewer is able to actively intervene in the events of the entertainment program. It is thus possible for example to influence or codetermine an action or the speech and gestures of an actor. A role corresponds for example to a character played by an actor or generated by a computer (for example a jury member or defendant in an entertainment program which is based on a legal theme).

A profile is understood to be a predefined plot line. In this situation, questions or selection options for example can be prepared according to profile. In this manner, a type of script is produced of all the possibilities conceivable within the framework of the entertainment program.

The concept of a question is understood as a collective term for selection options or requests to one or more or all viewers of the entertainment program. These may be responded to by one or more viewers by for example transmitting corresponding messages to the communication network. Questions can be transmitted by a producer of the entertainment program in the form of an actual question or a plurality of selection options to the viewers of one role or to all roles. Within the scope of the evaluation, however, only those response messages to questions are taken into consideration which are delivered by such viewers, or terminal devices, as conform to the previously defined role classification.

Questions can for example be specified by the producer. It is also conceivable that the questions be influenced or provided by the viewers.

The concept of the parameter is understood to be all the factors having an influence on the program, as expressed by a viewer. This expression can be made by pressing a key on the input device or sensory acquisition of a parameter for the viewer by the input device.

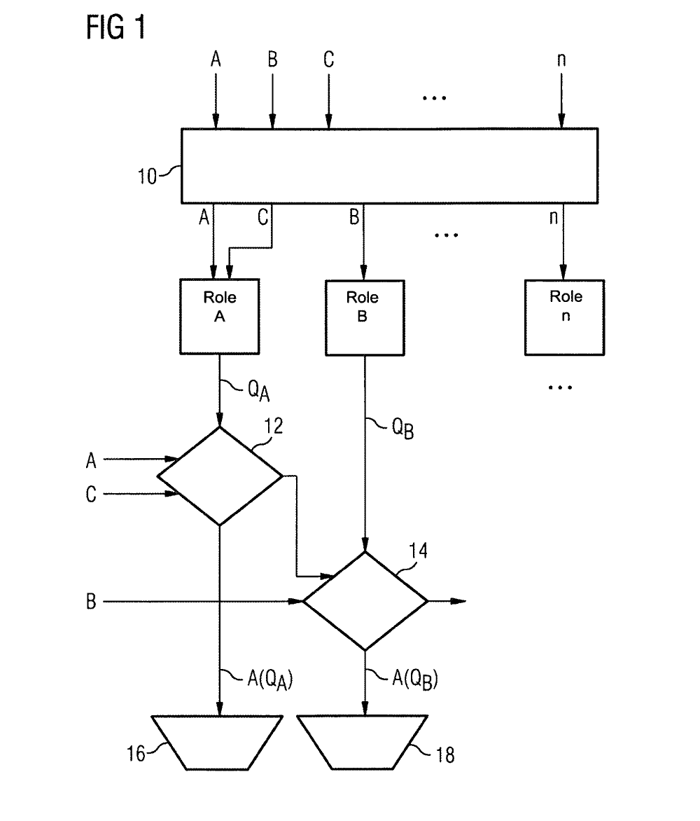

The process performed can be seen from FIG. 1. Viewers A, B, C, . . . , n are connected by way of their terminal devices, which can be controlled by input devices, to a processing unit 10 of a communication network. The viewers connected to the processing unit 10 are combined on account of individual characteristics to form one or more roles role A, role B, role n. In this situation, once a role has been assigned or chosen it can be retained permanently throughout the entire entertainment program or it may also be changed. The assignment or independent selection of a role is made by the actual viewer. A role can encompass one or as a general rule a plurality of viewers who alone or jointly can intervene in the action of the entertainment program. The role assignment is made for example through responding to questions or selection options, which are open to response for example during the initial part of the entertainment program. These are displayed on the terminal device of a respective viewer, whereby the viewer makes a corresponding selection by operating his input facility which can communicate with the terminal device. In response to this selection a message is transmitted to the processing unit 10 of the communication network, which makes the assignment of a respective viewer to a role. The viewers which match in one or more defined parameters and lie within a prespecified tolerance are thus combined in one of the roles. The viewers combined in a role can henceforth jointly influence the action, for example in the form of a majority decision when a voting procedure is carried out.

In the exemplary embodiment the viewers A and C are assigned to the role A. Viewer B is assigned to the role B. Viewer n is assigned to the role n. Profiles with characteristics and possible questions or selection options are defined for each of the roles role A, role B, role n. Thus, for example, a profile designated as Q_{A} for the role A is transmitted to the viewers assigned to the role A. The viewers A, C assigned to the role A now have the opportunity to respond to the questions or selection options presented to them for selection. This is done in the manner described above by the transmission of messages in response to the actuation of corresponding input facilities of the input devices of respective terminal devices. The opinions or reactions or emotions expressed by the viewers A, C are henceforth processed in a processing unit 12. The response underlying the question or the profile Q_{A} is used in order to influence the action of the entertainment program. Specifically, the response is used by the processing unit 12 as an input variable with regard to the provision of questions or selection options for a profile Q_{B} for the role B. The response calculated by the processing unit 12 thus influences the questions or selection options made available to the viewers for the role B. The events or the action are/is then changed, which in turn can evoke a reaction to the plot line for the role B, for example in the form in turn of questions to a role C provided to the answers of the viewers B, etc. The responses A (Q_{A}) and A (Q_{B}) are in addition delivered to containers 16, 18, in which the responses are stored.

The definition of the profiles of the different roles can take place shortly before the program is broadcast. Viewers can thereby be encouraged to participate in the entertainment program. This can happen for example by a brief description of the entertainment program and of the subsequent action. In addition, the viewers can actually be involved in the definition of the roles. The exchange between the viewers amongst themselves or with the producer can for example take place by chat.

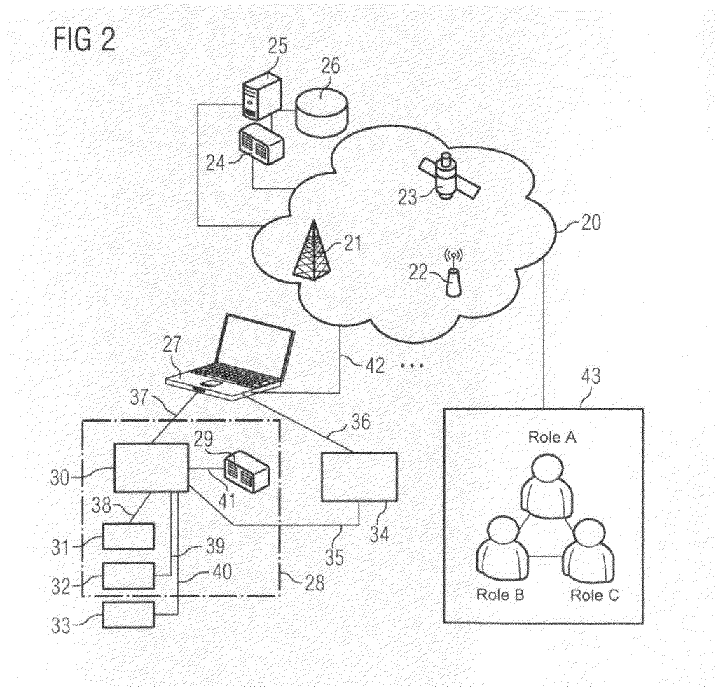

The topology required in order to execute the method is illustrated in FIG. 2.

A communication network 20 comprises facilities 21, 22, 23 for the simultaneous transmission of a content data stream representing an entertainment program to a plurality of terminal devices. By way of example, only one terminal device 27 is illustrated. In this situation, the transmission technology chosen by the communication network 20 can be of any desired type. The communication path between the terminal device 27 and the communication network 20 can be designed as wireless or wired. Connected to the network 20 are an analysis and evaluation unit 24, a processing unit 25 (server) and also a database 26. These elements can be networked together with one another in any desired manner.

An input device 28 is connected to the terminal device 27. The communication between the terminal device and the input device 28 can take place by way of a contact-type or wireless communication path 37. It is additionally possible, as can be seen from the schematic drawing, to connect a further input device 34 by way of a further communication path 36 to the terminal device. The input devices 28, 34 advantageously have a unique identifier in each case, which means that the messages initiated by them can be uniquely assigned to the input devices 28, 34 and thus to the viewers operating them.

The input device 28 comprises input facilities, in the form of a keypad or a touch screen for example, and also in the exemplary embodiment three sensors 31, 32, 33, for example in order to sense skin moisture content, sweat, pulse etc. Optionally, the input device 28 can have an analysis and evaluation unit which performs a preprocessing of the data generated or detected by the sensors and the input facility. Optionally, a reading device (RFID reader) can additionally be provided, which reads out data from an identification medium (chip card, for example) assigned to a viewer.

The data transmission between a respective sensor 31, 32, 33 takes place by way of communication paths 38, 39, 40, which can be designed as desired. The communication takes place with a central unit 30 of the input device 28.

Furthermore, the reference character 35 serves to identify a communication link between the two input devices 28, 34 which can exchange data with one another.

The content data stream broadcast by the communication network 20 comprises a plurality of roles, role A, role B, role C, whose actions can be influenced as a result of the decisions of the viewers, associated with the respective roles. This is symbolized by the reference character 43. With regard to the entertainment program, this can be action presented by an actor or computer-animated action.

The messages initiated by the input devices are transmitted by the terminal device 27 by way of a back channel of the communication path 42 to the communication network 20 and thus to the analysis and evaluation unit 24 and the processing unit 25. The latter can influence the action of the entertainment program through the roll profiles contained in the database 26 by transmitting corresponding questions or selection options for a particular role in turn to the terminal devices 27 of the viewers. The decisions for the roles are transmitted to those effecting the action, the actors for the role for example, so that the latter are able to adapt the action according to what the viewers select.

The content data stream representing an entertainment program can be altered by the viewers by executing the method to the effect that the viewer for example becomes the conqueror of dangers. The viewers have the ability, for example, to determine the daily routine of the actor. Viewers can for example slip into the role of jurors. In the case of a jury, the viewers can assume a role and jointly discharge it together with other participants and thus enter into interaction with one another. It is thus possible to specify questions relating to witness cross-examination, from which are selected one or more per majority decision. The selected questions can then be executed, vocalized for example, by an actor embodying the role or by a robot (avatars). Other viewers of the entertainment program can slip into the role of a judge or prosecutor.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-11. (canceled)

12. A method, comprising:
sending a content data stream representing an entertainment program from a processing unit of a communication network, the content data stream being sent to a remote terminal device;
outputting the content data stream from the terminal device;
using an input device to sense a physical state of a human operator of the input device;
forwarding a value representing the physical state to the terminal device;
transmitting the value from terminal device to the processing unit; and
manipulating the content data stream at the processing unit to conform with the physical state of the human operator.

13. The method of claim 12, further comprising receiving remote control commands at the input device and forwarding the remote control commands to the terminal device.

14. An input device, comprising:
a sensor to sense a physical state of a human operator of the input device; and
a transmitter to transmit a value representing the physical state to a terminal device for forwarding to a processing unit of a communication network so that the processing unit can manipulate a content data stream sent back to the terminal device, the content data stream representing an entertainment program.

15. The input device as claimed in claim 14, whereby the sensor senses at least one of skin moisture content, sweat, a pulse rate, and a heart rate.

16. The input device as claimed in claim 14, wherein the transmitter also transmits the value to another input device.

17. The input device as claimed in claim 14, further comprising an input facility to receive user input and create a message, the transmitter transmitting the message to the terminal device for forwarding to the processing unit.

18. The input device as claimed in claim 14, wherein the input unit combines the value representing the physical state with a unique identifier for the terminal device and transmits both the value and the unique identifier to the terminal device for transmission to the processing unit.

19. The input device as claimed in claim 14, wherein
the input unit combines the value representing the physical state with a unique identifier assigned to the input device, and
the input unit transmits both the value and the unique identifier to the terminal device for transmission to the processing unit.

20. The input device as claimed in claim 14, further comprising an analysis/evaluation unit to analyze/evaluate data received from the sensor.

21. The input device as claimed in claim 14, wherein the transmitter transmits using a wireless interface.

22. The input device as claimed in claim 14, wherein the transmitter transmits using a wired interface.

23. The input device as claimed in claim 14, further comprising a reading device to read data from an identification medium.

24. The input device according to claim 14, further comprising a receiver to receive remote control commands, the transmitter transmitting the remote control commands to the terminal device.

25. A terminal device, comprising:
a receiver to receive a content data stream representing an entertainment program from a remote processing unit of a communication network;
an output device to output the content data stream;
an evaluation unit to evaluate data representing a physical state of a human operator, received from an input device; and
a transmitter, connected to the evaluation unit, to transmit the data representing the physical state to the processing unit of the communication network.
